(19) United States
(12) Patent Application Publication
(10) Pub. No.: US 2008/0211961 A1
(43) Pub. Date: Sep. 4, 2008

(54) SEQUENTIAL SCANNING CONVERSION DEVICE AND IMAGE DISPLAY APPARATUS

(75) Inventor: Kiyoto KOJIMA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/037,527

(22) Filed: Feb. 26, 2008

(30) Foreign Application Priority Data
Mar. 2, 2007 (JP) 2007-052184

(51) Int. Cl. H04N 11/20

(52) U.S. Cl. 348/448; 348/E11.021

(57) ABSTRACT

A sequential scanning conversion device includes: N (N is 3 or larger integer) line memories which store each input image data of successive N main scanning lines contained in input image data for interlaced scanning; an input/output control unit which sequentially selects one of the N line memories and writes the input image data to the selected line memory, and also reads (N−1) input image data written to the other (N−1) line memories in such timing at least a part of which overlaps with the writing timing; and an image processing unit which produces output image data for sequential scanning corresponding to M (M is one or larger integer) main scanning lines by applying predetermined process established in advance to the (N−1) input image data.

The entire disclosure of Japanese Patent Application No. 2007-052184, filed Mar. 3, 2007 is expressly incorporated by reference herein.

### BACKGROUND

1. Technical Field

The present invention relates to a technology of converting an interlace image signal into a sequential scanning image signal.

2. Related Art

For achieving practical use of TV broadcast, the numbers of scanning lines and frames per second have been severely limited due to transmittable band restriction. Thus, interlaced scanning which divides one frame into two halves and updates each half frame to provide 60 frames per second has been employed based on utilization of afterimage effect for human eyes. In recent years, however, problems such as low vertical resolution of the image signal and flicker have been remarkable with the development of a high-resolution display. For overcoming these drawbacks, a technology for converting an input image signal in interlaced scanning into an image signal in sequential scanning having no interlace for image display has been proposed (see JP-A-2004-173182).

However, the related-art technology of sequential scanning conversion uses frame memories for storing pixel values within each frame, which raises the cost of the device. This problem has been more serious with increase in resolution and size of the display.

### SUMMARY

It is an advantage of some aspects of the invention to provide a technology for reducing memory circuit scale used in sequential scanning conversion.

A sequential scanning conversion device according to an aspect of the invention includes: N (N is 3 or larger integer) line memories which store each input image data of successive N main scanning lines contained in input image data for interlaced scanning; an input/output control unit which sequentially selects one of the N line memories and writes the input image data to the selected line memory, and also reads (N−1) input image data written to the other (N−1) line memories in such timing at least a part of which overlaps with the writing timing; and an image processing unit which produces output image data for sequential scanning corresponding to M (M is one or larger integer) main scanning lines by applying predetermined process established in advance to the (N−1) input image data.

According to the sequential scanning conversion device of this aspect of the invention, one of the N (N is 3 or larger integer) line memories for storing respective input image data of N main scanning lines contained in the input image data for interlaced scanning is sequentially selected, and the input image data is written to the selected line memory in the sequential scanning conversion process. Also, (N−1) input image data written to the other (N−1) line memories are read in such timing at least a part of which overlaps with the writing timing. Thus, highly efficient line memory management and simple and highly reliable line memory control can be simultaneously achieved.

The highly efficient memory management can be provided by the following method. According to the sequential scanning conversion, it is desired that image data of a plurality of main scanning lines used for sequential scanning conversion are outputted simultaneously with the timing for inputting image data of one main scanning line. This is because image data of adjacent plural scanning lines are required for producing image data of each scanning line in sequential scanning. For meeting this demand, the sequential scanning conversion device according to this aspect of the invention allows operation for writing image data of one main scanning line to one line memory simultaneously with operations for reading and writing image data of plural scanning lines required for sequential scanning conversion at all times by sequential selection (switching) of the plural line memories.

The simple and highly reliable line memory control can be provided by the following method. When attention is given to operation of each line memory in the memory management described above, each line memory is so designed as to execute only either reading operation or writing operation at the same time. According to this line memory control, no interference between reading operation and writing operation is caused in each line memory. Thus, necessity for considering possibility of such interference when creating the control logic is eliminated. Accordingly, advantages such as high reliability, simplification of the line memory control circuit, and power consumption reduction can be simultaneously provided.

According to the sequential scanning conversion device of this aspect of the invention, it is preferable that the N line memories are so designed to allow only either writing operation or reading operation at the same time. In this case, the circuit for the line memory can be simplified, and advantages such as high reliability and power consumption reduction can be further enhanced. According to the sequential scanning conversion device of this aspect of the invention, it is preferable that the value N is four.

Application of the invention is not limited to the sequential scanning conversion device, but may be an image display apparatus, an image display method, an image display control method, a program for controlling image display (or program product), a projector, and other various applications which use the sequential scanning conversion device. Image display in this case involves both self light emission display such as PDP and projection display.

### BRIEF DESCRIPTION OF THE DRAWINGS

The invention will be described with reference to accompanying drawings, wherein like reference numbers are given to like elements.

FIG. 1 is a block diagram showing a structure of a liquid crystal projector 10 according to an embodiment of the invention.

FIG. 2 illustrates an internal structure of an input image conversion unit 220 according to the embodiment of the invention.

FIG. 3 illustrates input image data to be inputted to the input image conversion unit 220 according to the embodiment of the invention.

FIG. 4 shows details of sequential scanning conversion process according to the embodiment of the invention.

FIG. 5 illustrates a dynamic image and a still image for explaining combing condition caused in sequential scanning conversion.

FIG. 6 is a timing chart showing operation of the input image conversion unit 220 according to the embodiment of the invention.

FIG. 7 illustrates a connection condition of the input image conversion unit 220 when input image data of scanning lines 1, 5 and 9 in interlace image data are written to a line memory a 222a.

FIG. 8 illustrates a connection condition of the input image conversion unit 220 when input image data of scanning lines 2, 6 and 10 in interlace image data are written to a line memory b 222b.

FIG. 9 illustrates a connection condition of the input image conversion unit 220 when input image data of scanning lines 3 and 7 in interlace image data are written to a line memory c 222c.

FIG. 10 illustrates a connection condition of the input image conversion unit 220 when input image data of scanning lines 4 and 8 in interlace image data are written to a line memory d 222d.

### DESCRIPTION OF EXEMPLARY EMBODIMENTS

Details of an embodiment according to the invention are now described in the following order:
A. Basic Structure of Liquid Crystal Projector
B. Internal Structure and Operation of Input Image Conversion unit 220
C. Memory Cycle in Sequential Scanning Conversion Process according to this Embodiment
D. Details of Sequential Scanning Conversion Process according to this Embodiment

D-1. Upper End Process

D-2. Combination of Filed Interpolation Process and Line Interpolation Process

D-3. Automatic Judgment Interpolation Process

D-4. Lower End Process
E. Modified Example

### A. BASIC STRUCTURE OF LIQUID CRYSTAL PROJECTOR

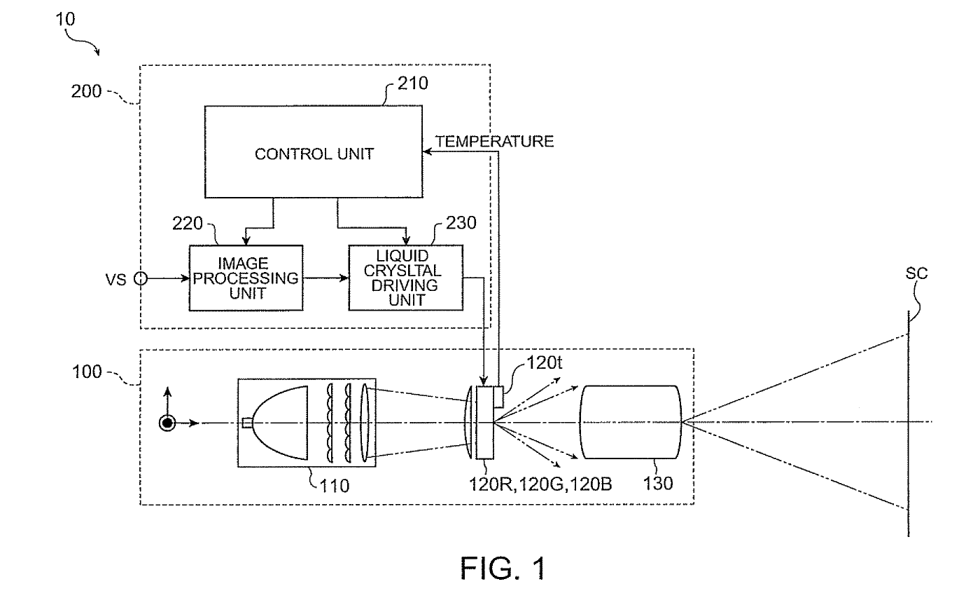

FIG. 1 is a block diagram showing a structure of a liquid crystal projector 10 according to an embodiment of the invention. The liquid crystal projector 10 includes an optical system 100 for projecting an image on a screen Sc, and a control system 200 for controlling the optical system 100. The optical system 100 has an illumination system 110, an LCD panel 120, and a projection system 130. The control system 200 has a control unit 210, an input image conversion unit 220, an image processing unit 230, and a liquid crystal driving unit 240.

The control unit 210 has not-shown CPU and memory. The control unit 210 controls the image processing unit 230 and the liquid crystal driving unit 240. The image processing unit 230 processes an input image signal given from the outside and generates an input signal to be inputted to the liquid crystal driving unit 240. The processes applied to the input image signal involve various processes such as image quality control process. The image quality control process contains luminance control and color temperature correction.

The input image conversion unit 220 converts input image data for interlaced scanning into image data for sequential scanning. The details of the structure and operation of the input image conversion unit 220 will be described later. The input image conversion unit 220 corresponds to “sequential scanning conversion device” in the appended claims.

The liquid crystal driving unit 240 generates driving signals for driving liquid crystal panels 120R, 120G and 120B based on image data inputted from the image processing unit 230. These driving signals are supplied to the liquid crystal panels 120R, 120G and 120B to be used for control over transmission light quantity of each pixel included in the liquid crystal panels 120R, 120G and 120B. Lights having passed through the liquid crystal panels 120R, 120G and 120B are supplied to the projection system 130. The projection system 130 projects the lights received from the liquid crystal liquid panels 120R, 120G and 120B on the screen SC. The liquid crystal panels 120R, 120G and 120B correspond to “an image display device” in the appended claims.

### B. INTERNAL STRUCTURE AND OPERATION OF INPUT IMAGE CONVERSION UNIT 220

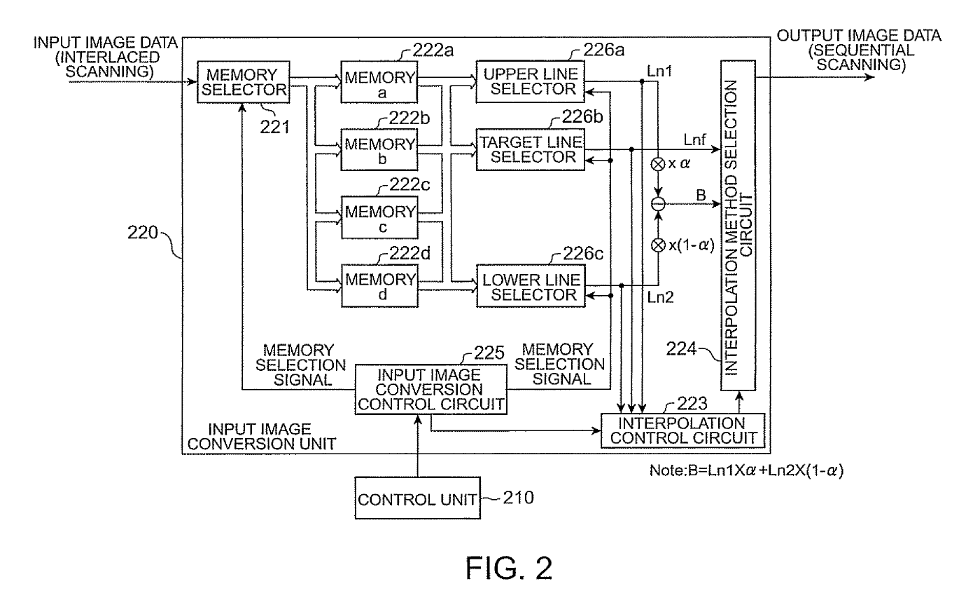

FIG. 2 shows the internal structure of the input image conversion unit 220 according to the embodiment of the invention. The input image conversion unit 220 has a memory selector 221, four line memories 222a, 222b, 222c and 222d, an upper line selector 226a, a target line selector 226b, a lower line selector 226c, an interpolation control circuit 223, an interpolation method selection circuit 224, and an input image conversion control circuit 225 for controlling these circuits in response to a command issued from the control unit 210.

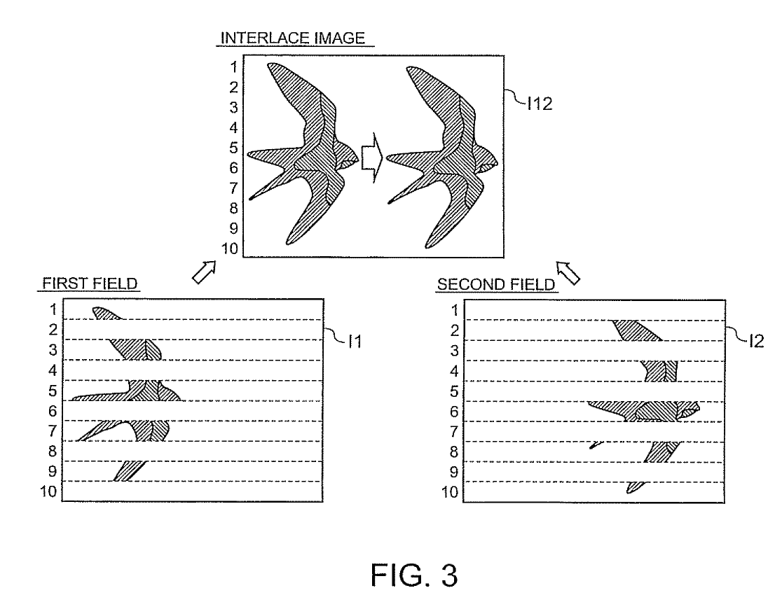

FIG. 3 illustrates input image data to be inputted to the input image conversion unit 220 according to the embodiment of the invention. The numerals on the left sides of first field image I1 and second field image I2 indicate the scanning line numbers. A bird in an interlace image I12 looks as if it is moving from the left to the right through the updating process of the first field image I1 and the second filed image I2 with a time difference ( 1/60 second) between the two images. This processing for image utilizes the afterimage effect of human eyes.

According to this embodiment, the input image data is constituted by the combination data of the first field image I1 and the second filed image I2. More specifically, the scanning lines having numbers (referred to as scanning line numbers as well) which are odd and the scanning lines having numbers which are even are constituted by input image data in the first filed image I1 and input image data in the second filed image I2, respectively. The input image data having this structure is hereinafter referred to as interlace image data.

The memory selector 221 (FIG. 2) selects one of the four line memories 222a, 222b, 222c and 222d in response to a command issued from the input image conversion control circuit 225, and writes the interlace image data to the selected line memory. More specifically, the scanning lines having the scanning line numbers 1 through 10 are sequentially selected, and the input image data contained in each of the scanning lines is written to one of the four line memories 222a, 222b, 222c and 222d.

The target line selector 226b selects a line memory from which the target line selector 226b reads input image data Lnf (for interlaced scanning) of the target scanning line corresponding to the output image data (for sequential scanning) to be produced from the line memories other than the line memory selected by the memory selector 221. The upper line selector 226a and the lower line selector 226c select line memories for storing input image data Ln1 of the scanning line positioned next to the target scanning line corresponding to the output image data (for sequential scanning) on the upper side and input image data Ln2 of the scanning line positioned next to the target scanning line on the lower side, respectively.

For producing output image data corresponding to the scanning line having the scanning line number “2”, for example, the target line selector 226b selects the line memory for storing input image data Lnf(2) corresponding to the scanning line having the scanning line number 2 in the second field image I2. The parenthesized numeral indicates the scanning line number. The upper line selector 226a and the lower line selector 226c select the line memory storing input image data Ln1(1) of the scanning line having the scanning line number 1 in the first field image I1 and the line memory storing input image data Ln2(3) of the scanning line having the scanning line number 3 in the first field image I1, respectively.

The input image conversion unit 220 converts the input image data thus obtained into output image data so created as to collectively update all the scanning lines. In this specification, this conversion process is referred to as sequential scanning conversion process.

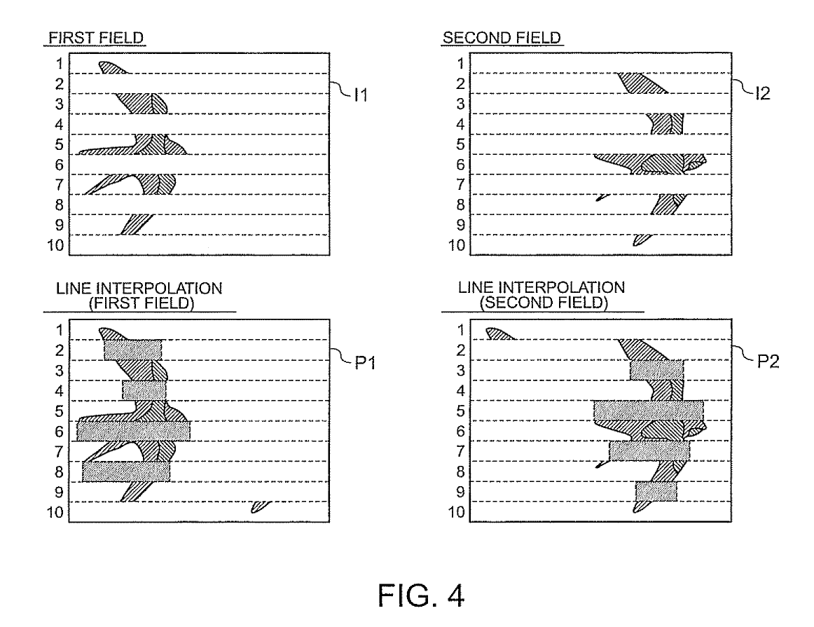

FIG. 4 illustrates details of the sequential scanning conversion process according to the embodiment of the invention. In this sequential scanning conversion process, the interlace image data I1 and I2 as dynamic image data (FIG. 3) are converted into two sequential scanning image data P1 and P2.

According to the sequential scanning conversion process for a still image, the input image data in the first field and the input image data in the second field are simply combined. This interpolation method is called field interpolation. According to the example discussed above, the input image data Lnf(2) of the second scanning line in the input image data in the second field image I2 corresponds to the output image data for sequential scanning. The output image data Lnf(2) is produced for each of the two frames such that frame fate of 1/60 second can be maintained.

In the sequential scanning conversion process for dynamic image, there are two types of line interpolation process according to this embodiment. The line interpolation process is a process for producing output image data P1 and P2 for sequential scanning for each of two frames based on the interlace image data I1 and I2. This process is required to prevent comb-shaped deterioration of image quality called combing caused due to relative difference between images in case of sequential scanning conversion process for dynamic image.

Combing is comb-shaped deterioration of image quality caused by relative difference between images. For preventing this image deterioration, interpolation process called field interpolation is executed using either the input image data in the first field or the input image data in the second field. In the field interpolation process, output image data is produced by combining respective input image data positioned next to the target scanning line on the upper and lower sides with predetermined ratio. According to the example discussed above, the input image data Ln1(1) and Ln2(3) in the first field image I1 are combined to produce output image data for sequential scanning.

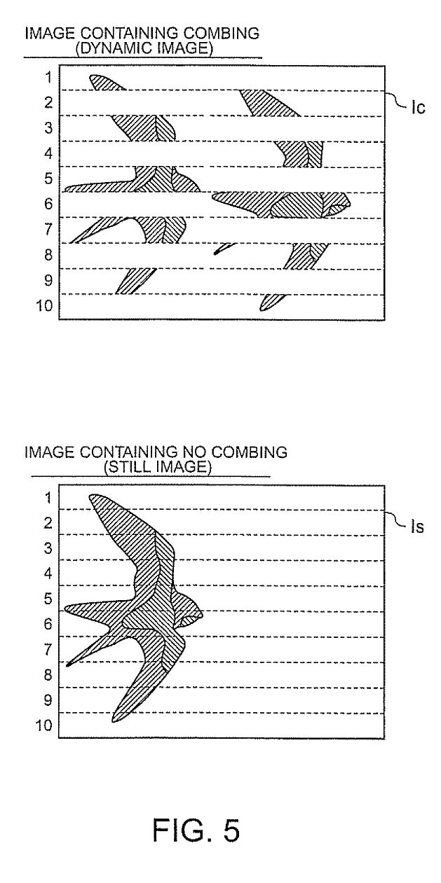

FIG. 5 illustrates conditions of a dynamic image and a still image for explaining combing in sequential scanning conversion process. A sequential scanning image Ic shows a condition containing combing caused by the sequential scanning conversion for dynamic image, and a sequential scanning image Is shows a condition containing no combing at the time of the sequential scanning conversion for still image. In the sequential scanning conversion, therefore, the processing to be performed is switched depending on whether the image to be processed is a still image or a dynamic image. This switching may be achieved by the control unit 210 which analyzes the condition and commands the input image conversion unit 220 to change the processing to be performed, for example, or may be automatically achieved by a method to be described later.

This switching is executed by the interpolation method selection circuit 224 in this embodiment. The interpolation method selection circuit 224 constantly receives both output image data Lfn (field interpolation process) which uses input image data of the respective scanning lines read by the target line selector 226b as output image data (for sequential scanning) without change, and output image data B (B=Ln1×α+Ln2×(1−α), line interpolation process) which uses output image data (for sequential scanning) produced by combining input image data (for interlaced scanning) for two scanning lines read by the upper line selector 226a and the lower line selector 226c.

The interpolation method selection circuit 224 selects either the output image data Lfn or the output image data B in response to a command from the interpolation control circuit 223. Selection between the output image data Lfn and the output image data B is made by the interpolation control circuit 223 based on comparison of the difference between the input image data Ln1 and input image data Ln2 with a predetermined threshold. More specifically, when the difference between the input image data Ln1 and input image data Ln2 is larger than the predetermined threshold, the interpolation control circuit 223 judges that the target image is a dynamic image and selects the output image data B. When the difference between the input image data Ln1 and input image data Ln2 is smaller than the predetermined threshold, the interpolation control circuit 223 judges that the target image is a still image and selects the output image data Lfn.

### C. MEMORY CYCLE IN SEQUENTIAL SCANNING CONVERSION PROCESS ACCORDING TO THIS EMBODIMENT

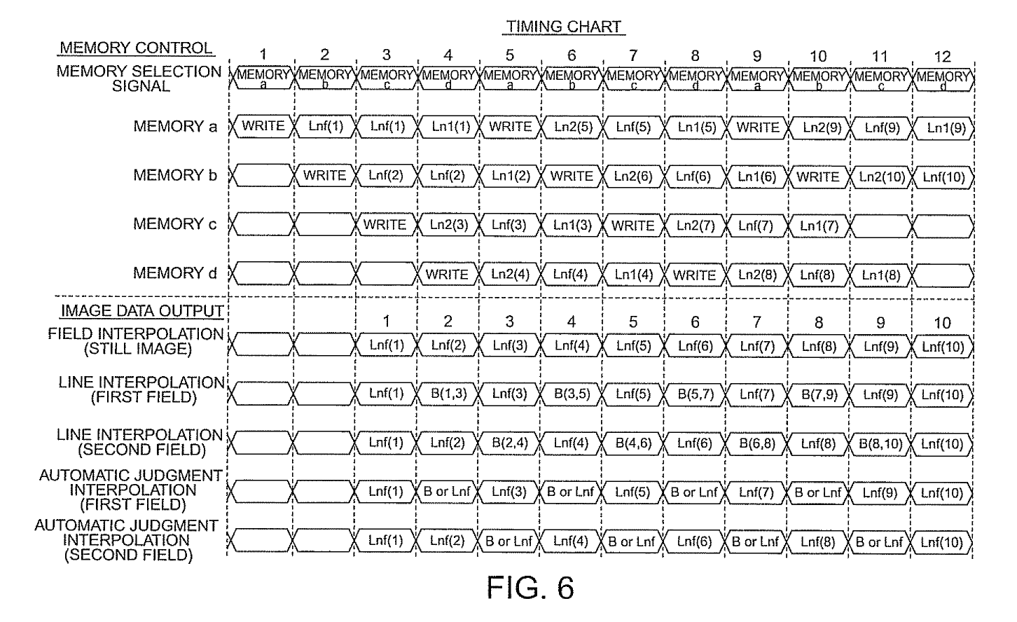

FIG. 6 is a timing chart showing operation of the input image conversion unit 220 according to the embodiment of the invention. This timing chart is constituted by a memory control part and an image data output (for sequential scanning) part. The numerals at the uppermost position of the memory control part indicate main scanning line numbers of the input image data for interlaced scanning (FIG. 3). The numerals at the uppermost position of the image data output (for sequential scanning) part indicate the main scanning line numbers of the output image data. According to this embodiment, sequential scanning conversion process is performed for interlace image data in this one frame for simplifying the explanation.

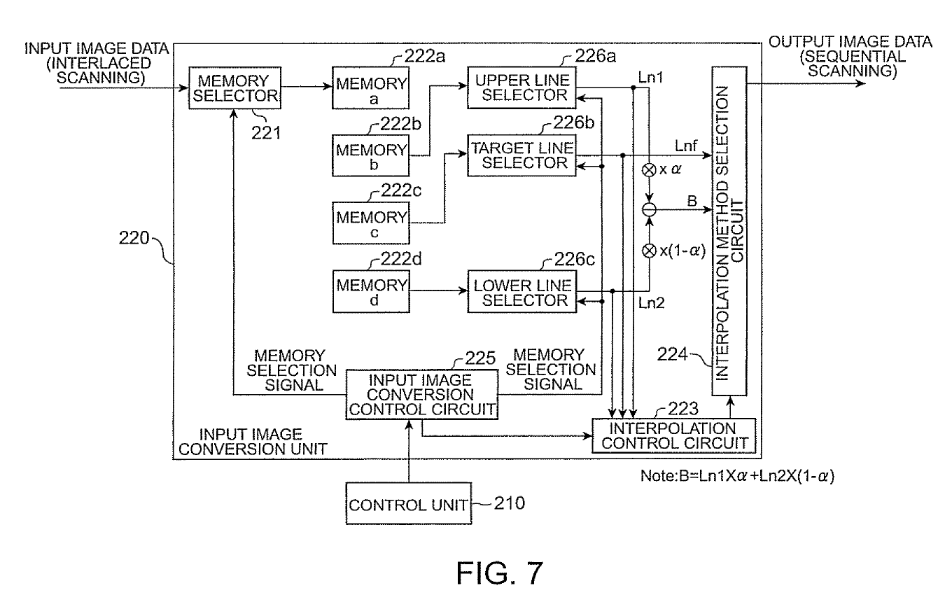

FIG. 7 illustrates a connection condition of the input image conversion unit 220 when each input image data of the scanning lines 1, 5 and 9 in the interlace image data (FIG. 3) is written to a line memory a 222a. As can be seen from FIG. 6, input image data is not stored in the other line memories 222b, 222c and 222d when the input image data of the scanning line 1 is written to the line memory a.

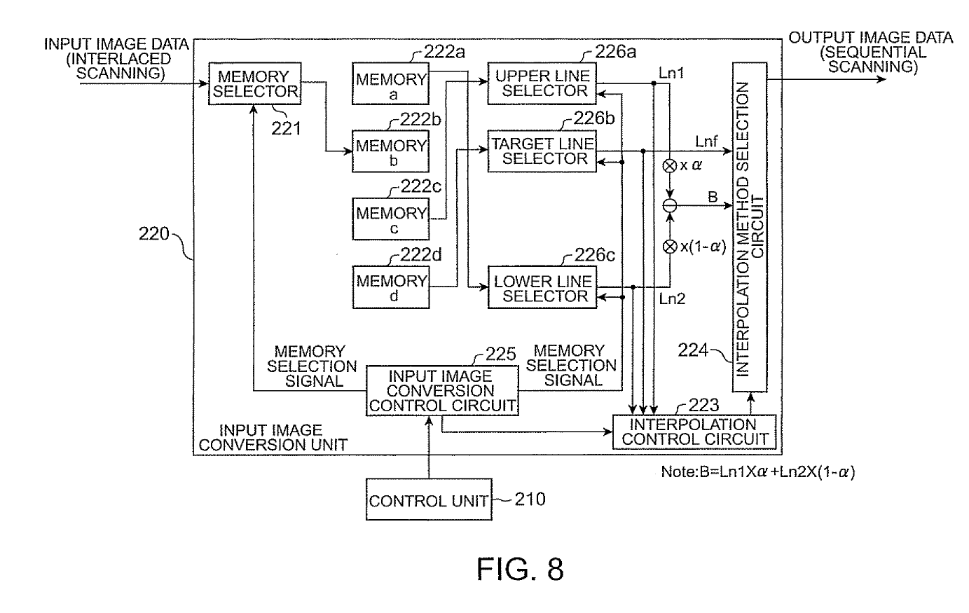

FIG. 8 illustrates a connection condition of the input image conversion unit 220 when each input image data of the scanning lines 2, 6 and 10 in the interlaced image data (FIG. 3) is written to a line memory b 222b. As can be seen from the timing charge in FIG. 6, the input image data of the scanning line having the scanning line number 1 is stored only in the line memory a 222a with no input image data stored in the other line memories 222c and 222d when the input image data of the scanning line 2 is written to the line memory b 222b.

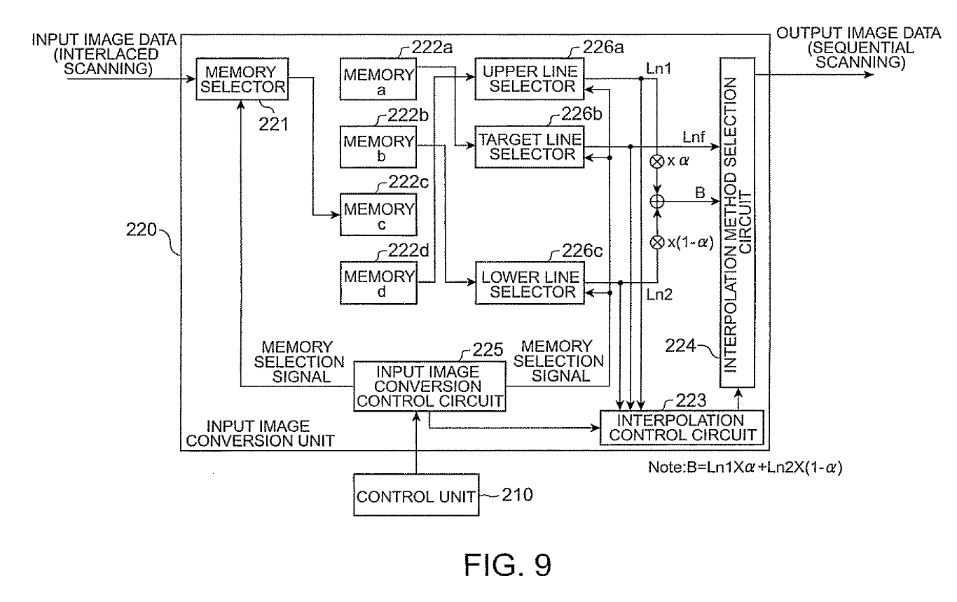

FIG. 9 illustrates a connection condition of the input image conversion unit 220 when each input image data of the canning lines 3 and 7 in the interlaced image data (FIG. 3) is written to the line memory c 222c. As can be seen from the timing charge in FIG. 6, the input image data of the scanning line having the scanning line numbers 1 and 2 are stored in the line memories a 222a and b 222b, respectively, with no input image data stored in the line memory 222d when the input image data of the scanning line 3 is written to the line memory c 222c.

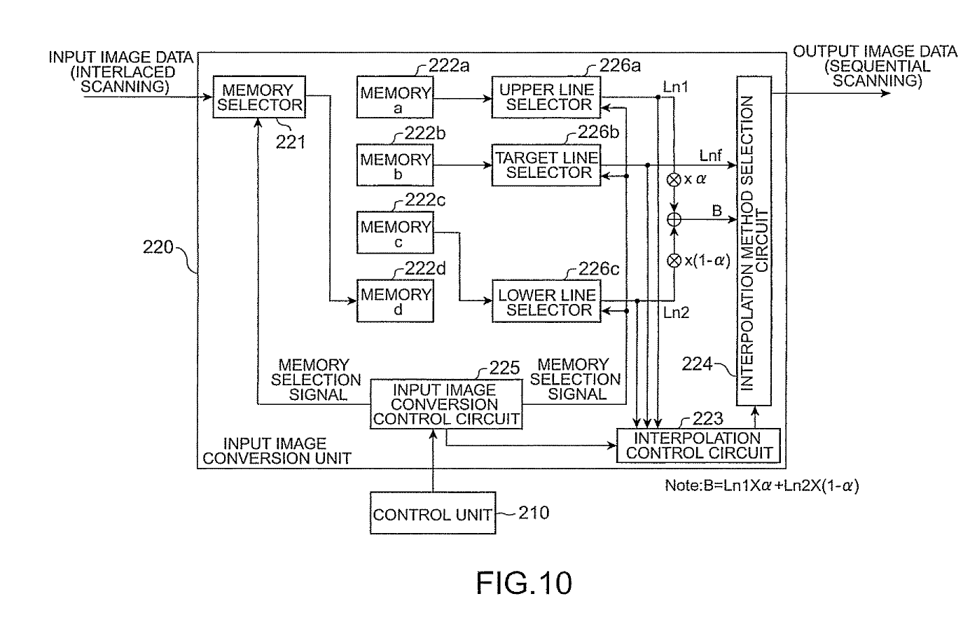

FIG. 10 illustrates a connection condition of the input image conversion unit 220 when each input image data of the scanning lines 4 and 8 in the interlaced image data (FIG. 3) is written to the line memory d 222d. As can be seen from the timing charge in FIG. 6, the input image data of the scanning line having the scanning line numbers 1 through 3 are stored in the line memories a 222a, b 222b, and c 222c, respectively, when the input image data of the scanning line 4 is written to the line memory d 222d.

The input image data of the scanning lines 1 through 10 in the interlace image data are sequentially written to the four line memories 222a, 222b, 222c and 222d by repeating these cycles. The interlace image data written by this method are efficiently read for sequential scanning conversion process in the following manner.

### D. DETAILS OF SEQUENTIAL SCANNING CONVERSION PROCESS ACCORDING TO THIS EMBODIMENT

D-1. Upper End Process

In the initial sequential scanning conversion process (FIG. 6), output image data of the scanning line having the main scanning number 1 is produced as an exceptional process for the upper end part of the image. Since the scanning line having the main scanning number 1 is the scanning line positioned at the upper end, the input image data of the scanning line having the main scanning number 1 in the interlace image data I1 is used as the output image data Lnf(1) without change. The parenthesized numerals indicate the main scanning numbers in the interlace image data I1 and I2.

This process is executed when the input image data of the scanning line 3 in the interlace image data (FIG. 3) is written to the line memory c 222c (FIG. 9). In this step, the input image data of the scanning lines 1 and 2 are stored in the line memories a 222a and b 222b as discussed above, and no input image data is stored in the remaining line memory 222d. Since the input image data of the scanning line having the main scanning number I in the interlace image data I1 is used as the output image data Lnf(1) without change in this case, the data in the line memories 222b, 222c and 222d are not used. The output image data Lnf(1) is produced for each of two frames to maintain frame rate of 1/60 second as explained above.

D-2. Combination of Filed Interpolation Process

In this sequential scanning conversion process, it is judged whether the target image is a dynamic image or a still image by a function outside the input image conversion unit 220, and the line interpolation process for dynamic image is performed. When it is judged that the target image is a dynamic image, the line interpolation process is carried out to produce the output image data B(1,3) and the output image data Lnf(2).

In the second sequential scanning conversion process, for example, output image data of the scanning line having the main scanning number 2 is produced. For the scanning line having the main scanning line number 2, the output image data B(1,3) is created by combining the input image data Ln1(1) of the scanning line having the main scanning number 1 and the input image data Ln2(3) of the scanning line having the main scanning number 3. The combining process is achieved by linear interpolation of the input image data Ln1(1) and input image data Ln2(3) using a coefficient α allowed to be set. More specifically, the output image data B(1,3) is produced as the sum of a value calculated by multiplying the gradation of the input image data Ln1(1) by the coefficient α and a value calculated by multiplying the gradation of the input image data Ln2(3) by (1−α).

This process is performed when the input image data of the scanning line 4 in the interlace image data (FIG. 3) is written to the line memory d 222d (FIG. 10). As can be seen from FIG. 6, the input image data of the scanning lines 1, 2 and 3 are stored in the line memories a 222a, b 222b and c 222c, respectively, when the input image data of the scanning line 4 is written to the line memory d 222d. By using the output image data (1,3) and the output image data Lnf(2) thus produced, the frame rate of 1/60 second can be maintained.

D-3. Automatic Judgment Interpolation Process

Automatic judgment interpolation process determines whether the target image is a dynamic image or a still image by a function inside the input image conversion unit 220 and executes line interpolation process for dynamic image. In this process, the automatic judgment interpolation process is carried out to produce one of the output image data B(1,3) and output image data Lnf(2) thus selected, and the output image data Lnf(2).

One of the output image data B(1,3) and output image data Lnf(2) is selected by the interpolation control circuit 223. More specifically, when the difference in gradation of each pixel between the input image data Ln1(1) and input image data Ln2(3) is smaller than a predetermined threshold established in advance, it is judged that the target image is a still image and selects the output image data Lnf(2). When the difference in gradation of each pixel between the input image data Ln1(1) and input image data Ln2(3) is larger than the predetermined threshold established in advance, it is judged that the target image is a dynamic image and selects the output image data B(1,3). This selection is executed by the switching function of the interpolation method selection circuit 224 based on the command from the interpolation control circuit 223.

D-4. Lower End Process

In the final sequential scanning conversion process, output image data of the scanning line having the main scanning number 10 is produced as an exceptional process for the lower end part of the image. Since the scanning line having the main scanning number 10 is the scanning line positioned at the lower end, the input image data of the scanning line having the main scanning number 10 in the interlace image data I1 is used as the output image data Lnf(10) without change.

Since the sequential scanning conversion process is performed according to these cycles, highly efficient line memory management and simple and highly reliable line memory control can be simultaneously achieved.

The highly efficient line memory management can be provided by the following method. According to the sequential scanning conversion discussed above, image data of three main scanning lines to be used for sequential scanning conversion are outputted at the time when image data of one main scanning line is inputted. Thus, operation for writing image data of one main scanning line to one line memory is allowed simultaneously with operations for reading and writing image data of plural scanning lines required for sequential scanning conversion at all times.

The simple and highly reliable line memory control can be provided by the following method. When attention is given to operation of each line memory in the line memory management described above, each line memory is so designed as to execute only either reading operation or writing operation at the same time. According to this line memory control, no interference between reading operation and writing operation is caused in each line memory. Thus, necessity for considering possibility of such interference when creating the control logic is eliminated. Accordingly, advantages such as high reliability, simplification of the line memory control circuit, and power consumption reduction can be simultaneously provided.

Moreover, this line memory control can use such line memory which allows only either reading operation or writing operation at the same time. By using this type of line memory, the circuit provided for the line memory can be simplified, and advantages such as high reliability and power consumption reduction can be further enhanced.

in addition, according to the findings through analysis of the present inventor based on the practical experiment, the scale of the line memory circuit in this embodiment is smaller than that of a structure having three line memories allowing reading operation and writing operation at the same time.

### E. MODIFIED EXAMPLE

The invention is not limited to the embodiments and examples described herein, and it is therefore intended that various modifications and changes may be made without departing from the scope and spirit of the invention.

E-1. While the four line memories are used in this embodiment, three line memories, for example, or five or more line memories may be used. The only requirement according to the invention is that, in the structure having N (N is 3 or larger integer) line memories for storing respective input image data of successive N main scanning lines contained in input image data for interlaced scanning, the input/output control unit sequentially selects one of the N line memories and writes the input image data to the selected line memory, and also reads (N−1) input image data written to the other (N−1) line memories in such timing at least a part of which overlaps with the writing timing.

E-2. While image data of one scanning line is produced from image data of three scanning lines in this embodiment, image data of one, two, or more (such as five or more) scanning lines may be produced from image data of four scanning lines, for example. Alternatively, output image data may be produced from image data of five ore more scanning lines, or may be produced from image data of two scanning lines.

E-3. While the transmission type liquid crystal panel 120R constituted by a transmission type liquid crystal panel is used in this embodiment, this is not restrictive, and a reflection type liquid crystal panel may be used. For example, the invention is applicable to a projector or other image display apparatus which uses a reflection type light modulation device such as non emission type display device including reflection type liquid crystal panel and digital micromirror device (DMD, trademark of U.S. Texas Instruments Inc.), emission type display device including PDP, EL, LED, and other display device using various types of electro-optical element.

What is claimed is:

1. A sequential scanning conversion device, comprising:
N (N is 3 or larger integer) line memories which store each input image data of successive N main scanning lines contained in input image data for interlaced scanning;
an input/output control unit which sequentially selects one of the N line memories and writes the input image data to the selected line memory, and also reads (N−1) input image data written to the other (N−1) line memories in such timing at least a part of which overlaps with the writing timing; and
an image processing unit which produces output image data for sequential scanning corresponding to M (M is one or larger integer) main scanning lines by applying predetermined process established in advance to the (N−1) input image data.

2. The sequential scanning conversion device according to claim 1, wherein the N line memories are so designed to allow only either writing operation or reading operation at the same time.

3. The sequential scanning conversion device according to claim 1, wherein the value N is four.

4. An image display apparatus which displays an image by sequential scanning based on input image data for interlaced scanning, comprising:
the sequential scanning conversion device according to claim 1 which produces the output image data for sequential scanning based on the input image data; and
an image display device which displays the image based on the output image data.

5. A projector which projects an image by sequential scanning based on input image data for interlaced scanning, comprising:
the sequential scanning conversion device according to claim 1 which produces the output image data for sequential scanning based on the input image data;
a light source; and
an image display device which modulates light supplied from the light source based on the output image data.

6. A sequential scanning conversion methods comprising:
preparing N (N is 3 or larger integer) line memories which store each input image data of successive N main scanning lines contained in input image data for interlaced scanning;
controlling input/output to sequentially select one of the N line memories and write the input image data to the selected line memory, and also read (N−1) input image data written to the other (N−1) line memories in such timing at least a part of which overlaps with the writing timing; and
processing image to produce output image data for sequential scanning corresponding to M (M is one or larger integer) main scanning lines by applying predetermined process established in advance to the (N−1) input image data.
